(19) United States
(12) Patent Application Publication
(10) Pub. No.: US 2025/0340120 A1
(43) Pub. Date: Nov. 6, 2025

(54) DIRECT FUEL GENERATED ELECTRICITY TO BODY FUNCTIONS

(71) Applicant: Oshkosh Corporation, Oshkosh, WI (US)

(72) Inventor: Jacob Wallin, Oshkosh, WI (US)

(73) Assignee: Oshkosh Corporation, Oshkosh, WI (US)

(21) Appl. No.: 19/197,242

(22) Filed: May 2, 2025

Related U.S. Application Data
(60) Provisional application No. 63/642,081, filed on May 3, 2024.

(51) Int. Cl. B60L 1/00; B60L 58/30; B65F 3/14

(52) U.S. Cl. CPC B60L 1/00; B60L 58/30; B65F 3/14; B60L 2200/44; B60L 2260/54

(57) ABSTRACT

A refuse vehicle is disclosed, comprising a secondary power source, an auxiliary system electrically connected to the secondary power source, a sensor, and processing circuitry with one or more processors and non-transitory, computer-readable media. The processing circuitry, when executed by the processors, receives a dataset from the sensor containing a primary attribute, predicts a load increase associated with the auxiliary system operation if the primary attribute meets a primary threshold, and upon predicting the load increase, sends a command to activate the secondary power source.

### CROSS-REFERENCE TO RELATED PATENT APPLICATIONS

This application claims the benefit of and the priority to U.S. Provisional Patent Application No. 63/642,081, filed May 3, 2024, the entire contents of which is hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

In some aspects, the techniques described herein relate to a refuse vehicle including: a primary power source; a secondary power source; an auxiliary system electrically coupled to the secondary power source; a sensor; one or more processors; and a computer-readable, non-transitory storage medium including instructions that, when executed by the one or more processors, cause the one or more processors to execute a method including: receiving a dataset from the sensor, the dataset including a primary attribute; predicting a load increase corresponding to an operation of the auxiliary system based at least in part on the primary attribute satisfying a primary threshold; and in response at least in part to predicting the load increase based on the primary attribute satisfying the primary threshold, transmitting an instruction to initiate the secondary power source.

In some aspects, the techniques described herein relate to a refuse vehicle, wherein the method further includes: receiving an indication of a completion of the operation of the auxiliary system; and in response at least in part to receiving the indication of the completion of the operation of the auxiliary system, transmitting a second instruction to terminate the secondary power source.

In some aspects, the techniques described herein relate to a refuse vehicle, wherein the primary power source is electrically coupled to a drivetrain of the refuse vehicle.

In some aspects, the techniques described herein relate to a refuse vehicle, wherein the auxiliary system includes: an auxiliary component electrically coupled to the secondary power source; and a device cooperatively coupled to the auxiliary component.

In some aspects, the techniques described herein relate to a refuse vehicle, wherein the auxiliary component is one of an electric power take-off, an electric motor, and a hydraulic pump.

In some aspects, the techniques described herein relate to a refuse vehicle, wherein the device is one of a lift assembly, an ejector, a compactor, and a vehicle access.

In some aspects, the techniques described herein relate to a refuse vehicle, wherein the secondary power source is an electric generator onboard the refuse vehicle.

In some aspects, the techniques described herein relate to a refuse vehicle, wherein the secondary power source is a hydrogen fuel cell.

In some aspects, the techniques described herein relate to a refuse vehicle, wherein the electric generator is powered by internal combustion of one of hydrogen, renewable natural gas, compressed natural gas, gasoline, and e-fuel.

In some aspects, the techniques described herein relate to a computer-readable, non-transitory storage medium including instructions that, when executed by one or more processors, cause the one or more processors to execute a method including: receiving a dataset from a sensor of a refuse vehicle, the dataset including a primary attribute; predicting a load increase corresponding to an operation of an auxiliary system of the refuse vehicle based at least in part on the primary attribute satisfying a primary threshold; and in response at least in part to predicting the load increase based on the primary attribute satisfying the primary threshold, transmitting an instruction to initiate a secondary power source of the refuse vehicle.

In some aspects, the techniques described herein relate to a computer-readable, non-transitory storage medium, wherein the method further includes: receiving an indication of a completion of the operation of the auxiliary system; and in response at least in part to receiving the indication of the completion of the operation of the auxiliary system, transmitting a second instruction to terminate the secondary power source.

In some aspects, the techniques described herein relate to a computer-readable, non-transitory storage medium, wherein a primary power source is electrically coupled to a drivetrain of the refuse vehicle.

In some aspects, the techniques described herein relate to a computer-readable, non-transitory storage medium, wherein the auxiliary system includes: an auxiliary component electrically coupled to the secondary power source; and a device cooperatively coupled to the auxiliary component.

In some aspects, the techniques described herein relate to a computer-readable, non-transitory storage medium, wherein the auxiliary component is one of an electric power take-off, an electric motor, and a hydraulic pump.

In some aspects, the techniques described herein relate to a computer-readable, non-transitory storage medium, wherein the device is one of a lift assembly, an ejector, a compactor, and a vehicle access.

In some aspects, the techniques described herein relate to a computer-readable, non-transitory storage medium, wherein the secondary power source is an electric generator onboard the refuse vehicle.

In some aspects, the techniques described herein relate to a computer-readable, non-transitory storage medium, wherein the secondary power source is a hydrogen fuel cell.

In some aspects, the techniques described herein relate to a computer-readable, non-transitory storage medium, wherein the electric generator is powered by internal combustion of one of hydrogen, renewable natural gas, compressed natural gas, gasoline, and e-fuel.

In some aspects, the techniques described herein relate to a computer-implemented method including: receiving a dataset from a sensor of a refuse vehicle, the dataset including a primary attribute; predicting a load increase corresponding to an operation of an auxiliary system of the refuse vehicle based at least in part on the primary attribute satisfying a primary threshold; and in response at least in part to predicting the load increase based on the primary attribute satisfying the primary threshold, transmitting an instruction to initiate a secondary power source of the refuse vehicle.

In some aspects, the techniques described herein relate to a computer-implemented method, further including: receiving an indication of a completion of the operation of the auxiliary system; and in response at least in part to receiving the indication of the completion of the operation of the auxiliary system, transmitting a second instruction to terminate the secondary power source.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, according to an exemplary embodiment; and

FIG. 2 is a block diagram of a vehicle, according to an exemplary embodiment.

FIG. 3 is a block diagram of a vehicle, according to an exemplary embodiment.

FIG. 4 is a top view of a vehicle on a collection route, according to an exemplary embodiment.

FIG. 5 is a flow diagram of a method for initiating one or more components of a vehicle, according to an exemplary embodiment.

FIG. 6 is a flow diagram of a method for initiating one or more components of a vehicle, according to an exemplary embodiment.

FIG. 7 is a flow diagram of a method for initiating one or more components of a vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Refuse collection vehicles are increasingly transitioning to electric or hybrid-electric architectures, which demand more efficient and intelligent control over how and when various onboard subsystems are powered. The systems and methods described herein relate to dynamic, event-driven control of such subsystems—particularly high-load auxiliary components such as lift assemblies, ejectors, and compactors—by predicting when these components will be needed and proactively initiating a suitable power source, including a secondary power source when appropriate. Using data from one or more onboard or external sensors, a control system identifies when a load event, such as a refuse cart pickup, is likely to occur. Based on this prediction, and optionally contingent on satisfying additional environmental, navigational, or vehicle-specific conditions, the system transmits instructions to activate one or more auxiliary systems and/or to initiate power delivery from a secondary power source. In doing so, the system ensures that the necessary components are pressurized, energized, or otherwise ready to operate precisely when needed—thereby reducing power waste, improving system responsiveness, and extending the useful life of the vehicle's primary power system. This proactive approach to subsystem control allows refuse vehicles to operate more efficiently by aligning power demands with real-time operational requirements.

According to at least one embodiment of the methods and systems described herein, a refuse vehicle (referred to herein as a vehicle) includes at least one sensor configured to predict or detect a load increase or load event (e.g., an event associated with increased power demand such as refuse collection, refuse compaction, or other high-power operations). When one or more processors (referred to herein as processors) predict an upcoming load event based on sensor data, the processors prepare for the event by transmitting a control signal to one or more auxiliary systems or subsystems. This signal initiates the one or more auxiliary systems or a secondary power source in anticipation of the predicted load.

In one embodiment, the sensor captures image data from the environment surrounding the refuse vehicle. The captured image data is transmitted to an object detection system, which processes the images to identify the presence of a refuse cart (referred to herein as a cart). Upon detecting a cart, the object detection system sends a signal to a control system, which transmits one or more control signals to an auxiliary component, such as a hydraulic pump, an electric motor, or a fuel cell, to initiate its operation in preparation for the load event. The vehicle may be equipped with multiple power sources, including a primary power source and a secondary power source. For example, a battery pack (e.g., the primary power source) may power the drivetrain and various interface systems, while a secondary power source may provide electrical power to one or more high-current auxiliary components, such as a cart collector, ejector, or compactor. The secondary power source may include an onboard electric generator, such as a hydrogen fuel cell or an internal combustion generator fueled by hydrogen, renewable natural gas, compressed natural gas, gasoline, diesel, or synthetic e-fuels. To manage electrical peaks, the vehicle may also incorporate minimal energy storage such as capacitors, small batteries, or a hydraulic accumulator.

In some embodiments, the processors additionally or alternatively perform an interlock check before initiating the auxiliary component or secondary power source through the control system. In such embodiments, an interlock system executes one or more computer-implemented methods to more accurately predict a load event. For example, prediction may depend on the presence of additional conditions—referred to herein as secondary conditions, tertiary conditions, or interlock conditions—beyond simply detecting a cart. These conditions may include, but are not limited to, vehicle speed being below a threshold, the vehicle approaching the cart, the cart being located on the correct side of the vehicle or on the collection route, battery level, hydraulic pressure, component temperature, operator presence, or certain environmental conditions.

The interlock system may receive datasets comprising data from various sensors, systems, or subsystems. Such data may include current operating parameter attributes of the vehicle, such as speed, steering angle, acceleration, velocity, cart engagement status, auxiliary component operation, power source level, hydraulic fluid condition, or high-voltage component temperature. The interlock system may also receive environmental attributes, such as weather conditions, cart characteristics (e.g., color, size, orientation, location, branding, labels), and obstacle-related data (e.g., size and location of nearby obstacles). Additionally, the interlock system may process navigation attributes, such as route trajectory, refuse pickup locations, direction of travel, historical routing data, and date or time.

Each received attribute may be compared against a predetermined or dynamically received attribute threshold to determine whether the condition is met. If so, the interlock system transmits an indication to the control system. Upon receiving this indication, the control system transmits a control signal to the auxiliary component or secondary power source to initiate its operation.

In some embodiments, the interlock system verifies one or more secondary conditions in addition to detecting the presence of a cart before signaling the control system. The interlock and object detection systems may operate in parallel or in series. For instance, the processor may run the object detection system until a cart is detected, and only then execute the interlock logic. Alternatively, the interlock system may run first and trigger object detection only once its own conditions are met. In yet other configurations, the interlock system may run continuously and, once a condition is met, allow object detection to proceed. In a tiered implementation, a secondary attribute may be monitored until it satisfies a secondary threshold, at which point a primary attribute (e.g., cart presence) is evaluated. If both conditions are satisfied, the system evaluates a tertiary attribute against a tertiary threshold. Once all three thresholds are met, the interlock system transmits a signal to the control system to initiate the auxiliary component or secondary power source.

In other embodiments, the interlock system compares the attributes in parallel, and if all corresponding thresholds are met concurrently, the system signals the control system.

The auxiliary component may include, for example, a hydraulic pump, electric motor, or fuel cell. It may be part of an auxiliary system and may be cooperatively coupled to one or more devices on the vehicle. These devices may include, but are not limited to, a lift assembly, an ejector, a refuse collector (such as gripper arms or platforms), a cart grabber, a compactor, a vehicle access mechanism (e.g., stairs or platforms), doors, or a hopper lid. In one configuration, the auxiliary system includes an electric motor that rotates a hydraulic pump to increase fluid pressure, thereby enabling the device to extend, retract, or articulate as needed.

In one embodiment, the vehicle predicts an upcoming cart collection and determines that one or more additional secondary or tertiary conditions are satisfied. In response, the controller transmits a control signal to the electric motor, initiating its operation and causing the cooperatively coupled hydraulic pump to rotate. This preemptively increases pressure in the auxiliary system before the vehicle arrives at the load event location.

In various implementations, initiating the electric power take-off (or other auxiliary component) may include initiating a secondary power source onboard the vehicle. For instance, the primary power source may be a battery pack used to power the drivetrain and other low-load systems, while the secondary power source may be responsible for high-load components such as lift assemblies and compactors. The secondary power source may be a hydrogen fuel cell, electric generator, alternator, capacitor, or secondary battery. In such embodiments, the control system sends an instruction to activate the secondary power source, such as by commanding a fuel cell to begin generating electricity. This generated electrical power may then be used to power the electric motor, which in turn drives the hydraulic pump.

In some configurations, inrush current generated during startup of the auxiliary component (such as the E-PTO, alternator, or electric generator) is directed to another auxiliary device, such as a compactor. This current spike, which traditionally is dissipated or stored, may instead be harnessed during the final phase of a compaction cycle. For example, a compaction cycle may be delayed until a predicted load event is about to occur, thereby allowing the system to take advantage of the inrush current during component startup.

In an illustrative example, a refuse vehicle includes a camera system mounted near the front corner of the body, a processor module inside the cab, and a secondary power source comprising a hydrogen fuel cell. As the vehicle approaches a residential street on its designated collection route, the camera captures image data that reveals a refuse cart located at the edge of the sidewalk. The processor uses this image data to extract a primary attribute and determine that a load event is likely to occur. Simultaneously, GPS data indicates that the vehicle is within a geofenced service area, satisfying a secondary condition. A speed sensor confirms the vehicle is decelerating to below a speed threshold, satisfying a tertiary condition. Having satisfied all three thresholds, the interlock system signals the control system to activate the hydrogen fuel cell. Electrical power from the fuel cell is routed to an electric motor, which drives a hydraulic pump. By the time the lift assembly reaches the cart, the hydraulic system is fully pressurized, and the cart is smoothly lifted and emptied into the vehicle with no operational delay. After the compaction cycle completes using redirected inrush current, the secondary power source is deactivated until the next predicted load event.

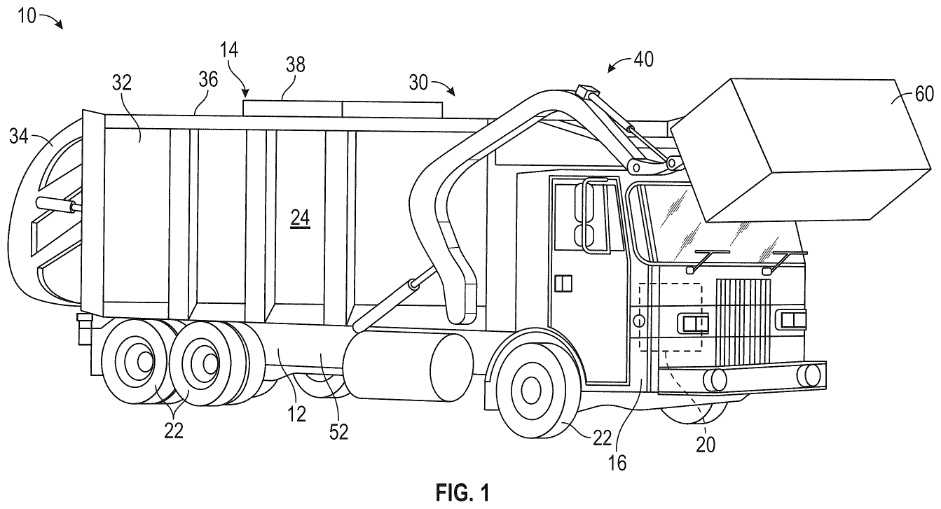

Referring to FIG. 1, a vehicle, shown as refuse vehicle 10 (e.g., garbage truck, waste collection truck, sanitation truck, etc.), includes a chassis, shown as frame 12, and a body assembly, shown as body 14, coupled to the frame 12, for example at a rear portion. A cab 16 is also coupled to the frame 12, typically toward the front of the vehicle. The cab 16 may include various operator-facing components to support manual control of the vehicle, such as a seat, steering wheel, hydraulic controls, user interface devices, switches, dials, and buttons. In addition, the cab 16 may house computing components including controllers or processors configured to automate or coordinate various vehicle operations.

A prime mover 20 is mounted to the frame 12, generally positioned beneath the cab 16. The prime mover 20 provides mechanical energy to one or more drive components, shown as wheels 22, and may also power other systems throughout the vehicle, including hydraulic, pneumatic, or electrical systems. Each pair of wheels 22 may be supported by an axle, and the vehicle may include two or more axles depending on its application. For instance, in some configurations, the refuse vehicle 10 may have four or five axles.

The prime mover 20 may be powered by a variety of fuel types, such as gasoline, diesel, biodiesel, ethanol, or natural gas. In certain embodiments, the prime mover 20 may be implemented as one or more electric motors mounted to the frame 12. These motors may draw power from onboard energy storage systems (such as batteries or capacitors), onboard generation systems (such as combustion-based generators, solar panels, or regenerative braking systems), or external sources (such as utility lines). A wide variety of alternative vehicle configurations are contemplated.

In one arrangement, the refuse vehicle 10 is equipped to collect waste materials from distributed containers and transport the collected waste to a destination such as a landfill, incinerator, or recycling facility. The body 14 includes an onboard refuse container that defines a collection chamber 24. As illustrated, the collection chamber 24 is enclosed by a series of panels 32, a tailgate 34, and a cover 36. Loose refuse is deposited into a compartment 30, where it may be compacted and temporarily stored before final disposal. In some variants, the compartment 30 may be positioned partially over or forward of the cab 16, but in the embodiment depicted, it is located behind the cab 16.

The compartment 30 may be divided into a hopper volume and a storage volume. Refuse is typically introduced into the hopper volume and then compacted into the storage volume. For example, the hopper may be positioned ahead of the storage section, supporting front-loading or side-loading configurations. In alternative designs, the storage volume may be forward of the hopper, enabling rear-loading operation via the tailgate 34.

The tailgate 34 is mounted at the rear end of the body 14 and is operable to open for unloading. In the embodiment shown, the tailgate 34 pivots about pins located near the top edge of the container, although alternative mounting arrangements are possible.

The refuse vehicle 10 also includes a lift assembly 40 mounted to the body 14, which may be positioned at the front, rear, or side depending on vehicle configuration. The lift assembly 40 is configured to engage a container 60 (e.g., a residential or commercial bin, or an automated cart with a mechanical interface). The lift assembly 40 may include hydraulic, electric, or pneumatic actuators that facilitate gripping the container 60, lifting it, and tipping its contents into the hopper volume of compartment 30. After emptying, the container 60 may be returned to its original position.

A door, shown as top door 38, is movably coupled to the cover 36 and is used to enclose the opening through which refuse is deposited. The top door 38 helps contain debris and prevent escape of materials during vehicle movement or adverse weather conditions.

This configuration enables the refuse vehicle 10 to support various waste collection operations while accommodating flexible drive, lift, and containment architectures. Power for operating the lift assembly 40 and other components may be provided by different energy systems onboard the vehicle, including energy storage, energy generation, and distribution components integrated throughout the frame and body.

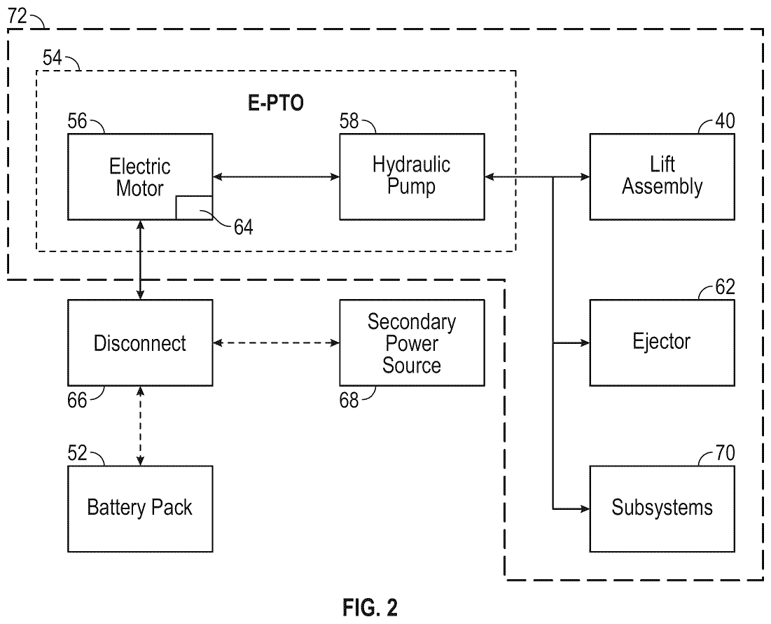

Referring to FIG. 2, in embodiments where the vehicle is implemented as an electric refuse vehicle or a hybrid refuse vehicle (e.g., the refuse vehicle 10 of FIG. 1)—including configurations that utilize both electric and hydraulic systems—the vehicle may include an onboard energy storage device for powering various vehicle systems. In one embodiment, the onboard energy storage device includes a battery pack 52 (e.g., a primary power source) configured to supply electrical power to a motor for driving the vehicle. The battery pack 52 (e.g., the primary power source) may also provide electrical energy to other subsystems and components distributed throughout the vehicle.

In addition to the drivetrain, the vehicle may include an electric power take-off system, shown as E-PTO system 54. The E-PTO system 54 is configured to receive electrical power from the battery pack 52 and/or from a secondary power source 68. The E-PTO system 54 converts the received electrical power into hydraulic energy to support one or more subsystems on the vehicle, including those used during auxiliary function cycles (e.g., refuse collection). For example, electrical power may be supplied from the energy storage device to an electric motor 56, which in turn drives a hydraulic pump 58. The hydraulic pump 58 delivers pressurized fluid to various devices, such as a lift assembly 40, an ejector 62, or one or more other subsystems (e.g., shown as other subsystems 70) (e.g., tailgate controls, hopper mechanisms, etc.). These components may be actuated based on a transmitted control signal for initiating the operation of an auxiliary system.

The E-PTO system 54 may include a controller, shown as E-PTO controller 64, which monitors, manages, and adjusts operational behavior across various subsystems. The E-PTO controller 64 may receive input from one or more sensors (not shown) distributed throughout the vehicle. These sensors may generate data associated with measured parameters such as voltage, current, temperature, or pressure. The E-PTO controller 64 may compare the received parameters to predefined thresholds and modify the operation of the E-PTO system or auxiliary system components accordingly. For instance, the E-PTO controller 64 may transmit a control signal to initiate or terminate operation of the auxiliary system 72, or in response to a detected critical condition, shut down the E-PTO system 54 or the entire vehicle to protect system integrity.

In some configurations, a disconnect 66 is positioned electrically between the battery pack 52 and the E-PTO system 54. The disconnect 66 enables selective decoupling of the auxiliary system 72 from the energy source, allowing individual components—such as the ejector 62, the lift assembly 40, or other subsystems—to be de-energized independently. The E-PTO controller 64 may command the disconnect 66 to open or close in response to a detected condition, including those derived from load prediction, sensor values, or fault detection. This architecture allows controlled and conditional initiation of auxiliary systems based on the detected need or the presence of relevant environmental or operational conditions.

In some embodiments, the E-PTO system 54, the lift assembly 40, the ejector 62, and the other subsystems 70 may collectively form an auxiliary system 72. The secondary power source 68 may be operably coupled to the auxiliary system 72 through the disconnect 66 and may be activated or deactivated based on dynamic operating requirements. For example, a controller may determine whether to initiate operation of the secondary power source 68 by evaluating whether one or more conditions are satisfied. These conditions may include load predictions, system readiness, or threshold satisfaction. In some cases, the secondary power source 68 may remain idle until a predefined trigger is met, at which point a signal is transmitted to initiate operation of the secondary power source and/or the auxiliary system 72.

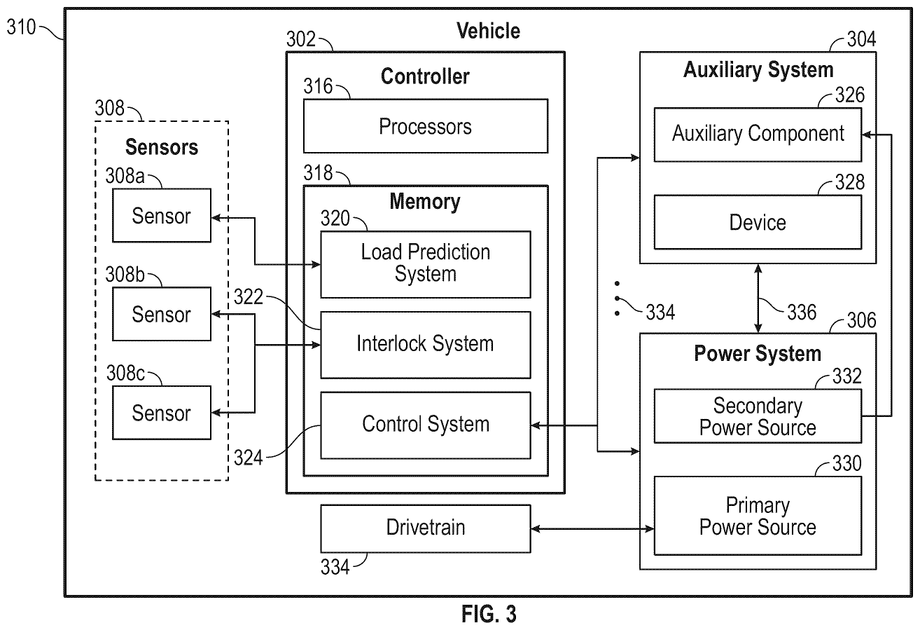

While FIG. 2 illustrates the battery pack 52 (e.g., the primary power source) as being electrically connected to the auxiliary system 72, in some embodiments the battery pack 52 may additionally or alternatively be coupled to a propulsion system or drivetrain, as further illustrated in FIG. 3. The power distribution across these systems may be dynamically managed to prioritize load response, vehicle mobility, and auxiliary function responsiveness during refuse collection operations.

Turning now to FIG. 3, a vehicle 310 is shown. In various embodiments, the vehicle 310 is substantially similar to the refuse vehicle 10 of FIG. 1 and may include some or all of the described components in FIGS. 1-2. The vehicle 310 may include a controller 302, an auxiliary system 304, a power system 306, a sensor 308a, a sensor 308b, and/or a sensor 308c (collectively referred to herein as sensors 308). The controller may include one or more processors (shown as a processor 316) and a memory 318. The memory 318 may include various subsystems or modules stored in non-transitory, computer-readable media. For example, the memory 318 may include a load prediction system 320, an interlock system 322, and/or a control system 324. In some embodiments, these systems interact in real time with the auxiliary system 304 to manage high-load events based on sensed parameters and environmental conditions.

Controller 302 may be implemented as a general-purpose processor, an application specific integrated circuit (ASIC), one or more field programmable gate arrays (FPGAs), a digital-signal-processor (DSP), and/or circuits containing one or more processing components, circuitry for supporting a microprocessor, a group of processing components, or other suitable electronic processing components. In various embodiments, the controller 302 includes processing circuity for executing instructions stored in the non-transitory, computer-readable media of the memory 318. The processing circuitry may include one or more processors, shown as the processor 316, which may include an ASIC, one or more FPGAs, a DSP, and/or circuits containing one or more processing components or circuitry for supporting a microprocessor, a group of processing components, and/or other suitable electronic processing components. The memory 318 may be any volatile or non-volatile computer-readable storage medium capable of storing data or computer code relating to the methods described herein and instructions to execute the methods described herein. According to an exemplary embodiment, the memory 318 includes computer code modules (e.g., executable code, object code, source code, script code, machine code, etc.) configured for execution by processor 316. In some embodiments, the processor 316 may represent a collection of processing devices (e.g., servers, data centers, etc.). In such cases, the processor 316 represents the collective processors of the devices, and memory 318 represents the collective storage devices of the devices. The processor 316 may execute one or more of the systems or subsystems stored in the memory 318, such as the load prediction system 320, the interlock system 322, and/or the control system 324. This processing environment may manage a dynamic queue of predicted load increases and issue control signals for initiating operation of the auxiliary system based on operating parameters received from the sensors 308.

The memory 318 (and by extension, the various subsystems stored in the memory 318, such as load prediction system 320, the interlock system 322, and/or the control system 324) may be communicatively coupled (e.g., wiredly or wirelessly) to one or more of the sensors 308. By way of a non-limiting example, the sensor 308a may be communicatively coupled to load prediction system 320, the sensor 308b may be communicatively coupled to the interlock system 322, and the sensor 308c may be communicatively coupled to the interlock system 322, as shown in FIG. 3. Though any of the sensors 308 may be coupled to one or more of the systems stored in the memory 318. The load prediction system 320, the interlock system 322, and/or the control system 324 may receive sensor datasets including various sensor data from the sensors 308 to which they are communicatively coupled. This received sensor data is stored in the various subsystems and used in executing the methods described herein. The datasets may include values corresponding to parameters such as temperature, battery state of charge, hydraulic pressure, GPS position, and other telemetry relevant to high-load subsystem activation.

Load prediction system 320 may contain instructions for predicting upcoming high-load events such as cart collection or refuse compaction. For ease of description, a process of cart collection is described as illustrative of a high-load event caused by the high electrical loads required to collect a cart. However, it should be understood that the load prediction system 320 may be used to detect any additional or alternative high-load event, or combinations of events that result in a high electrical load. In some implementations, this includes comparing detected objects to thresholds indicative of required energy draw.

In some embodiments, the load prediction system 320 may contain instructions for detecting objects (e.g., a cart, a person, an obstacle, an operator, a mailbox, etc.) surrounding the vehicle 310. By way of example, the methods described herein relate to detecting carts for collection by the vehicle 310. However, it should be understood that the methods and systems described herein may be directed to any suitable object that the load prediction system 320 detects.

In an embodiment, the load prediction system 320 receives a dataset from the sensor 308a. The sensor 308a may be one of various sensors for collecting environmental data surrounding the vehicle 310. For example, the sensor 308a may be one or more of cameras, LiDAR (Light Detection and Ranging) sensors, radar (Radio Detection and Ranging) sensors, ultrasonic sensors, infrared sensors, thermal sensors, laser rangefinders, depth cameras, and/or 3D imaging sensors. While a sensor 308a is shown singularly in FIG. 3 for ease of description, the sensor 308a may include one or more sensors coupled to the vehicle 310. Likewise, the sensor 308b and the sensor 308c may also include multiple sensors. In some embodiments, the sensor 308a may not be physically coupled to the vehicle 310, rather, the sensor 308a may be physically coupled to another vehicle or other object (e.g., a perception module or a satellite). In such embodiments, the sensor 308a is communicatively coupled to the controller 302 through a network (not shown). Likewise, any of the sensors 308 may be physically removed from the vehicle 310 and communicatively coupled to the controller 302 through the network (not shown).

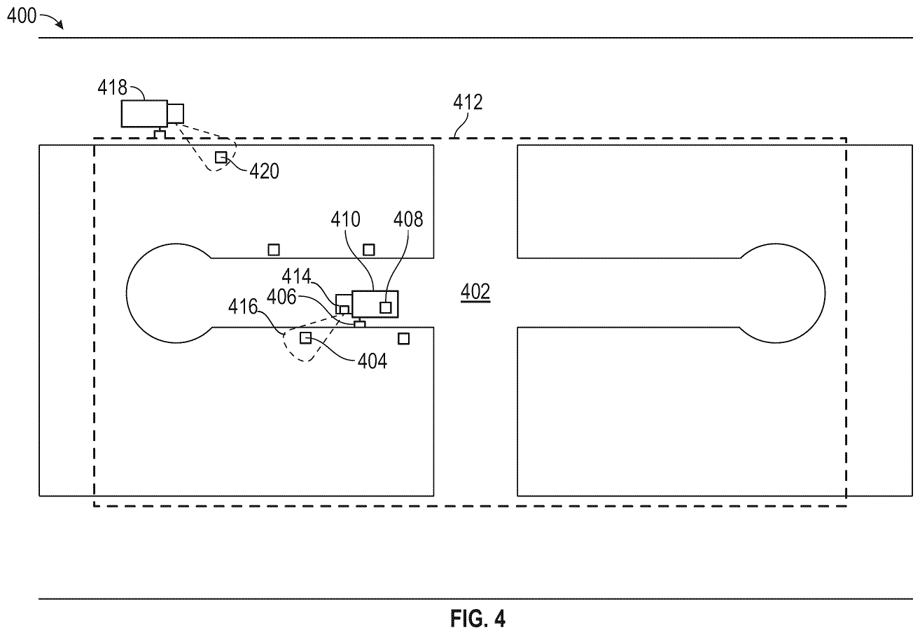

The sensor 308a receives perception data from an area defining a perception area (shown in FIG. 4 as a perception area 416) around the vehicle 310, the perception data including one or more object attributes of an object near the vehicle 310. The object attribute may be considered, in some embodiments, as a primary attribute. The primary attribute may be used to detect the object near the vehicle 310 within the perception area. Detecting the object by the load prediction system 320 may include detecting the presence of the object near the vehicle 310 and/or detecting various characteristics of the object (e.g., color, text on the object, position of the object, distance to the object, orientation of the object, type of object, size of the object, an estimated weight of the object, a volume of the object). The perception data may include, in some embodiments, images from the sensor 308a (e.g., a still camera or video camera). The load prediction system 320 may include image processing instructions for processing the received images to extract the various characteristics and/or attributes of the images. In some embodiments, the load prediction system 320 determines a confidence value associated with the likelihood that the detected object or characteristic is correctly detected (e.g., a higher confidence value signifies a higher likelihood that a detected cart is present). This confidence value may serve as a threshold parameter, and when met or exceeded, may serve as a trigger for subsequent evaluation of interlock conditions.

In an exemplary embodiment, the vehicle 310 includes a camera (the sensor 308a). The camera collects image data from a perception area surrounding the vehicle 310 and transmits the collected data to the load prediction system 320. The load prediction system 320 receives the transmitted image data and processes the images to extract various characteristics and/or attributes (e.g., size, orientation, location) of an object within the images and determines a distance to the position of the object based on known, positional datums of the camera in relation to the vehicle 310. The load prediction system 320 detects the presence of the object based on the extracted characteristics and/or attributes. In at least one embodiment, the sensor 308a is a standalone camera specifically utilized to detect carts. In other embodiments, the sensor 308a is used for multiple perception functions such as autonomous and semi-autonomous driving.

Upon detecting the presence (or other attribute) of the object, the load prediction system 320 transmits an indication to the interlock system 322 indicating the presence (or other detected attribute) of the object. This inter-system communication may include structured parameter datasets formatted to trigger evaluation routines stored within the interlock system 322.

The interlock system 322 contains instructions for determining when to initiate the operation of the auxiliary component 326 and/or the secondary power system 332 of the vehicle 310. The auxiliary system 304 may be substantially similar to an auxiliary system 72 of FIG. 2. For example, the auxiliary system 304 of FIG. 3 may include an auxiliary component 326 that corresponds to one or more components of the E-PTO system 54 of FIG. 2 (e.g., the electric motor 56 and/or the hydraulic pump 58). The auxiliary system 304 of FIG. 3 may include a device 328 which may correspond to one or more of the lift assembly 40, the ejector 62, and/or the other subsystems 70 of FIG. 2. In various embodiments, the interlock system 322 contains instructions for initiating the operation (through control signals transmitted from the control system 324) of an electric motor or hydrogen fuel cell (e.g., the secondary power system 332).

In an embodiment, the interlock system 322 determines to initiate the operation of the auxiliary component 326 or the secondary power system 332 based on the detection of an object (e.g., a cart) by the load prediction system 320. However, in various other embodiments, the interlock system 322 determines to initiate the operation of the auxiliary component 326 based on one or more additional interlock conditions. Interlock conditions may be conditions that must be satisfied (in addition to the presence of the object) prior to the interlock system 322 determining to initiate operation of the auxiliary component 326. An interlock condition may be considered satisfied when one or more secondary attributes satisfy corresponding thresholds. The secondary attributes may be received from the sensor 308b and/or the sensor 308c. Secondary attributes may correspond to, for example, an environment attribute, a vehicle attribute, and/or a navigation attribute.

Secondary attributes that are environment attributes may include, but are not limited to weather conditions, cart or refuse container attributes (e.g., color, size, orientation, location, branding, labels), and/or obstacle conditions (e.g., existence of an obstacle, size of an obstacle, location of an obstacle). Secondary attributes that are vehicle attributes may include, but are not limited to one or more current operating parameter attributes of the vehicle, such as speed, steering angle, acceleration, velocity, cart engagement, auxiliary component operation, power source level, hydraulic oil condition, and/or high-voltage component temperature. Secondary attributes that are navigation attributes may include, but are not limited to route trajectory, refuse pickup locations, direction of travel, historical navigation data, and/or date/time.

Additional secondary attributes may include power source attributes, a hydraulic system attributes, a high voltage component attribute, a vehicle attribute, an operator attribute, an object attribute, a weather attribute, an obstacle detection, a hopper capacity, a navigation route, a current location, and a user input.

One or more of these (and/or additional) received attributes may be compared against predetermined and/or received attribute thresholds to determine if the received attribute satisfies a corresponding attribute threshold, thus indicating that the condition is met. Upon determining that the condition is met, the interlock system 322 may transmit an indication that the condition is met to the control system 324. Upon receiving the indication that the condition is met, the control system 324 transmits a control signal to the auxiliary component 326 or secondary power system 332 to initiate operation of the auxiliary component 326 or the secondary power system 332.

In some embodiments, the interlock system 322 checks one or more secondary conditions, in addition to detecting a presence of a cart by the load prediction system 320, prior to sending an indication to the control system 324 to initiate the auxiliary component 326. The interlock system 322 and load prediction system 320 may operate in parallel or in series. By way of example, the processors may operate the load prediction system 320 until a cart is detected. Upon detecting the cart, the processors then execute the interlock system 322 to determine if secondary conditions are met. In other embodiments, the interlock system 322 runs until the interlock condition(s) are met, at which point an indication is sent by the interlock system 322 to the load prediction system 320 that the secondary condition is met and to initiate the load prediction system 320. In some embodiments, the interlock system 322 runs continuously in the background, and upon the interlock condition being met, the load prediction system 320 is executed. In some embodiments, a secondary attribute is received by the interlock system 322 until the secondary attribute satisfies a secondary threshold, at which point the load prediction system 320 begins receiving sensor data (including a primary attribute) to determine if a cart is present. Once the secondary threshold is met and a cart is detected (e.g., the primary attribute satisfies a primary threshold), the interlock system 322 then begins receiving a tertiary attribute to compare against a tertiary threshold. Once the tertiary threshold is met by the tertiary attribute, the interlock system 322 transmits to the control system 324 an indication that all conditions are met and instructions to transmit control signals to the auxiliary component 326 to initiate operation. The control system 324, in response to receiving the indication, transmits corresponding control signals to the auxiliary component 326 to initiate operation.

Secondary attributes may indicate probable loading conditions to increase the accuracy of predicting a load event of the vehicle 310. For example, in receiving (from the sensor 308b, such as a GPS module) a geographical position attribute (e.g., GPS coordinates) of the vehicle 310, the received geographical position attribute may be compared to a geographical position threshold (e.g., a geofenced area) to determine if the vehicle 310 is within the geofenced area. The geofenced area may correlate to a neighborhood along a collection route of the vehicle 310 and can be used to more accurately predict that carts detected when the vehicle 310 is in the geofenced area are more likely to be loaded. Additional interlock conditions that the interlock system 322 may use to determine whether to transmit instructions to initiate operation of the auxiliary component 326 include the vehicle 310 traveling at a speed above or below a speed threshold, the vehicle 310 traveling in a specific direction (e.g., such that the object is on a loading side of the vehicle 310), the destination of the vehicle 310, text on the cart matching a known text indicating that the cart is associated with the vehicle 310, an indication that there is no personnel near the cart, a battery level below or above a threshold, a fuel level above or below a fuel threshold, and/or a current compaction state above or below a threshold. The sensor 308b may collect data related to a first secondary attribute (e.g., vehicle 310 position) and the sensor 308c may collect data related to a second secondary attribute (e.g., vehicle 310 speed).

The auxiliary system 304 may include one or more auxiliary components (e.g., the auxiliary component 326) and/or devices (e.g., the device 328). In an exemplary embodiment, the auxiliary component 326 may be an E-PTO, such as the E-PTO system 54 of FIG. 2. The auxiliary system 304 may be a hydraulic system that drives one or more hydraulic devices (e.g., the device 328 such as a lift assembly, an ejector, a compactor, etc.). The hydraulic system operates (e.g., the device 328 extends, retracts, articulates) in some embodiments due to increased pressure within one or more hydraulic lines caused by a hydraulic pump spinning. The hydraulic pump is coupled to an electric motor that spins the hydraulic pump to cause an increase in pressure. Spinning the electric motor to increase pressure requires power from one or more power sources (e.g., the secondary power system 332). As such, reducing the operation of the auxiliary component 326 to only the times at which it is needed is advantageous as it reduces power consumption. However, there is often a lag between the initiation of the electric motor and reaching a working pressure of the hydraulic system. As such, the interlock system 322 provides a benefit of reducing power consumption between load events by only operating the electric motor when needed, but also reducing lag time for executing the load event by initiating the operation of the electric motor prior to arriving at a location where the predicted load event is to take place.

In some embodiments, the auxiliary component 326, in addition to the drivetrain, is electrically coupled to a primary power system 330. The primary power system 330 may be a battery, hydrogen fuel cell, internal combustion engine, nuclear reactor, or other means of providing power to the vehicle 310. In an exemplary embodiment, the primary power system 330 is a battery pack coupled to the drivetrain of the vehicle 310. In some embodiments, the auxiliary component 326 is electrically coupled to the secondary power system 332 (shown by an electrical connection 336). In an exemplary embodiment, the primary power system 330 is a battery back and the secondary power system 332 is a hydrogen fuel cell. However, the secondary power system 332 may be any other suitable power source, such as an internal combustion engine, a battery pack, and/or a capacitor.

In some embodiments, the secondary power system 332 to which the auxiliary component 326 is electrically coupled must be initiated in order for the auxiliary component 326 to initiate operation. For example, the vehicle 310 is powered by a battery pack (the primary power system 330). The lift assembly (e.g., the auxiliary component 326) which is used for engaging with a cart and loading the contents of cart into a compaction area within the vehicle 310 is powered by a hydrogen fuel cell (e.g., the secondary power system 332). The hydrogen fuel cell is not in operation between load events because the lift assembly is only needed during lift events. Thus, upon the controller 302 predicting a load event (through execution of the various subsystems stored within the memory 318), control signals 334 are transmitted to the secondary power system 332 and or the auxiliary component 326 to initiate operation to build pressure within the hydraulic system (e.g., the auxiliary system 304) to actuate the lift assembly.

In some embodiments, the auxiliary component 326 is electrically coupled to additional auxiliary components (e.g., additional motors) or other devices (e.g., a compactor). In such embodiments, an inrush current produced during the initial transitory electrical state of the auxiliary component 326 may be transmitted to the additionally coupled auxiliary component or device. For example, during startup of the auxiliary component 326, the processor 316 may adjust the flow of electricity through one or more switches/disconnects to transmit the inrush current to a second auxiliary component (not shown) coupled to a compactor. When the additional inrush current is transmitted to the second auxiliary component, in some embodiments, the controller 302 also transmits control signals to the secondary auxiliary system to initiate operation to utilize the inrush current. For example, the controller 302 may delay a compaction cycle of collected refuse until a load event is predicted and the auxiliary component 326 is initiated. By doing so, the otherwise wasted inrush current produced during the startup of the auxiliary component 326 is utilized during the compaction of the refuse. As such, a predicted load event may result in control signals 334 being transmitted by the load prediction system 320 or the interlock system 322 to various subsystems (e.g., the auxiliary component 326 and the second auxiliary component) simultaneously or near simultaneously. In some embodiments, the interlock system 322 may transmit subsequent instructions to the control system 324 to terminate operation of the auxiliary component 326 of the secondary power system 332 at the conclusion of the load event, the instructions.

Turning now to FIG. 4, a system 400 is shown for executing one or more of the methods described in FIGS. 1-3. The system 400 may include a vehicle 410 with an auxiliary component 408, a device 406, and/or a sensor 414. The auxiliary component 408 may be used to provide hydraulic pressure to the device 406. As shown in FIG. 4, the device 406 may be a lift assembly for lifting a cart 404 and articulating such that the contents of the cart 404 are emptied into the vehicle 410. The sensor 414 may receive image data for a perception area 416. As illustrated in FIG. 4, the cart 404 may be within the perception area 416 during operation of the vehicle 410. The captured (or obtained) image data of the cart 404, including data related to one or more attributes of the cart 404, is transmitted in a dataset to one or more subsystems of the vehicle 410 to be processed. One or more processors of a controller of the vehicle 410 process the images to determine the presence (and/or other attribute) of the cart within the perception area 416. In some embodiments, the perception area 416 is positioned such that any cart 404 detected within the perception area 416 is (or will soon be) within a reach of the device 406 during a collection movement.

In these embodiments, the dataset may include at least one primary attribute derived from the perception data, such as object position, shape, size, orientation, or contrast against background elements. The attribute values may be encoded numerically or spatially and stored with a timestamp and confidence score for subsequent evaluation by one or more subsystems configured for predicting a load increase. The sensor 414 may be, for example, a forward-facing camera, a stereo camera pair, or a LiDAR scanner mounted on the cab or body of the vehicle 410.

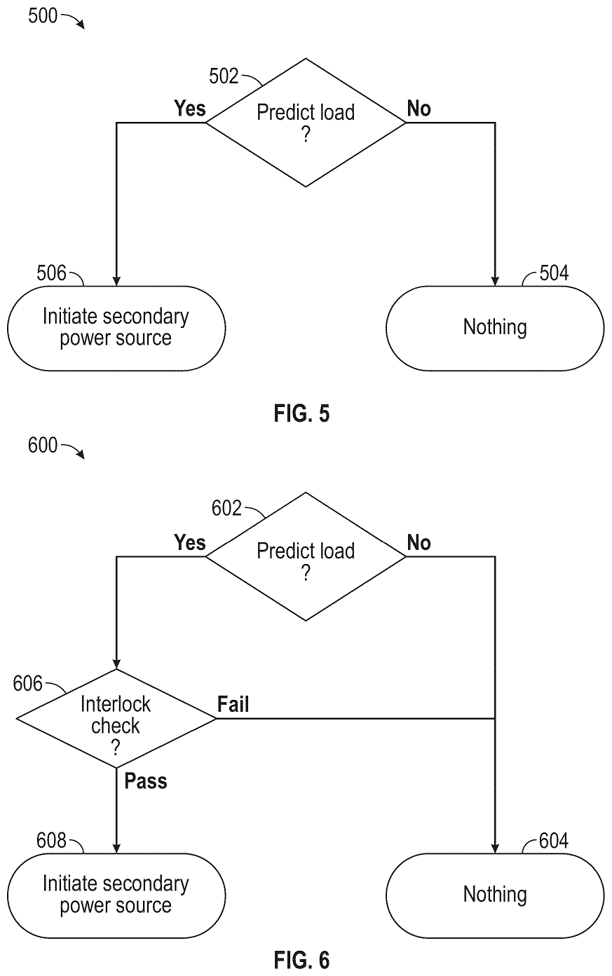

The processors process the images to extract one or more primary attributes of the cart 404, such as a distance in front of the vehicle 410 and/or a distance from a drivable surface 402 upon which the vehicle 410 is traveling. In some embodiments, the attribute of the cart 404 is a confidence level of an object detection system of the vehicle 410 that determines the presence of the cart 404. In other embodiments, the confidence level is determined from an object detection system of the vehicle 410. One or more of these primary attributes are compared to corresponding thresholds (e.g., predetermined threshold within a memory of the controller, received by a user input, received from a network). In some embodiments, the primary threshold is based on a type of vehicle 410, a type of device 406, and/or a type of auxiliary component 408. Upon the primary attribute satisfying the primary threshold (e.g., the object detection system has a satisfactorily high confidence level of a presence of the cart 404, the cart 404 being within a predefined distance from the vehicle 410, the cart 404 being within a predefined distance from the drivable surface 402), an indication of the presence of cart 404 is sent to an interlock system (e.g., interlock system 322 of FIG. 3) to determine if all necessary conditions are satisfied. In some embodiments, a presence of the cart 404 is the only necessary condition to be satisfied (e.g., as shown in FIG. 5).

In these cases, once the primary attribute satisfies the primary threshold, a control signal is transmitted from the interlock system to initiate operation of the auxiliary component 408. This control signal may include an instruction to energize a motor, engage a hydraulic circuit, or close a switching element between the auxiliary component 408 and a secondary power source onboard the vehicle 410. The control signal may also include metadata, such as an expected load duration, load type identifier, and time-to-execute value, to further optimize system response.

In other embodiments, additional interlock conditions must be met prior to initiation of the auxiliary component 408 (e.g., as shown in FIGS. 5-6) or a secondary power source electrically coupled to the auxiliary component 408. For example, an interlock condition may be that the vehicle 410 must be within a predefined geofenced area 412 (e.g., along a collection route or within a neighborhood) prior to initiating the auxiliary component 408 of the secondary power source upon detection of the cart 404. As shown in FIG. 4, the vehicle 410 is within the threshold of the predefined geofenced area 412, which the processors determine by comparing a received geographical position (e.g., GPS coordinates) to the predefined geofenced area 412. The current geographical position received by the processors may be transmitted by an additional sensor (not shown), such as a GPS receiver that receives global positioning information, in a secondary dataset with a secondary attribute (e.g., geographic positional coordinates). This secondary attribute is extracted from the secondary dataset and compared to a secondary threshold (e.g., the predefined geofenced area 412) to determine if the secondary threshold is satisfied. Upon determining, by the processor, that secondary attribute is satisfied (e.g., within the predefined geofenced area 412), an instruction is transmitted to a control system of the vehicle 410 to transmit control signals to the auxiliary component 408 (or power source) to initiate operation in preparation for collection of the cart 404 (e.g., a load event). In other words, a load event is predicted when both the primary threshold and the secondary threshold are satisfied, and a control signal is then sent to an auxiliary component and/or the secondary power source to initiate operation of the auxiliary component and/or the secondary power source in preparation of executing the predicted load event.

The activation of the secondary power source may involve starting a hydrogen fuel cell, spinning up a combustion-based generator, or engaging a high-voltage battery segment isolated from the drivetrain. This staged power-up sequence ensures that the auxiliary component 408 is pressurized or energized prior to reaching the cart 404, reducing lag and improving the timing of lift engagement. Predicting the load increase in advance of the physical interaction enables efficient resource allocation across subsystems.

In contrast, a vehicle 418 detecting a cart 420 would not initiate operation of the auxiliary component in a system requiring both the primary threshold and the secondary threshold to be satisfied because the secondary threshold (e.g., the geofence threshold) would not be satisfied by the vehicle 418 because it is outside of the predefined geofenced area 412. In some embodiments, there are multiple alternative secondary thresholds that may be satisfied to initiate operation of the auxiliary component.

For example, if the vehicle 418 is within a known historical collection corridor, or the operator has engaged a manual override confirming the intent to collect the cart 420, such secondary thresholds may be substituted in lieu of geographic fencing. Secondary thresholds may also include time-of-day windows, alignment between cart orientation and vehicle heading, or route-based heuristics indicating a probable collection scenario.

Additionally, in some embodiments, a tertiary threshold must be satisfied to initiate operation of the auxiliary component and/or secondary power source. In such embodiments, a tertiary dataset is received by the processors from a third sensor, the tertiary dataset including one or more tertiary attributes (e.g., a speed of the vehicle 410). The tertiary attribute is extracted from the tertiary dataset and compared against a tertiary threshold, as described with the primary threshold and the secondary threshold. Upon determining that the tertiary attribute satisfies the tertiary threshold (and the primary and secondary threshold remain satisfying the corresponding primary and secondary threshold), an indication that all three thresholds are satisfied is transmitted to the control system with instructions to transmit control signals to initiate operation of the auxiliary component.

The system may thereby prevent premature or unnecessary activation of the auxiliary component 408, ensuring that the operation is only triggered when a cart 404 is confidently detected, the vehicle 410 is in the correct geographic or logical position, and it is traveling below a speed threshold conducive to lifting or loading. Upon successful validation of all required thresholds, the controller issues the control signal to initiate operation, beginning a coordinated energy distribution and device engagement cycle tailored to the predicted load increase.

In an illustrative embodiment, the vehicle 410 is operating along a scheduled residential collection route and is equipped with a forward-mounted camera functioning as sensor 414. As the vehicle 410 enters the predefined geofenced area 412 corresponding to a specific neighborhood, the sensor 414 captures image data defining a perception area 416 in front of the vehicle. The perception area includes a cart 404 (e.g., a residential cart) placed near the curb. The object detection system processes the captured image and determines, based on extracted characteristics (e.g., shape, height, and contrast), that the object is a refuse cart. The confidence value associated with the detection exceeds a predefined primary threshold, and the spatial position of the cart 404 is within a predefined distance from the vehicle and from the drivable surface 402.

Upon satisfying these conditions, the load prediction system transmits an indication of cart presence to the interlock system. The interlock system concurrently receives GPS data from an onboard navigation module and verifies that the vehicle's current position is within the predefined geofenced area 412, thus satisfying the secondary threshold. A tertiary threshold is also evaluated by comparing a vehicle speed parameter from an onboard inertial sensor to a maximum speed threshold; the current speed of the vehicle 410 is below this limit.

With all three thresholds satisfied—the cart 404 is detected with high confidence, the vehicle 410 is within the designated route boundary, and it is moving at an appropriate collection speed—the interlock system transmits an indication to the control system that the conditions for initiating the auxiliary component 408 are met. The control system responds by transmitting a control signal to the auxiliary component 408, which includes an electric motor coupled to a hydraulic pump. The motor is energized using power from a secondary power source, such as a hydrogen fuel cell. The resulting hydraulic pressure actuates the device 406, which is a lift arm configured to grip and elevate the cart 404, dumping its contents into the hopper of the vehicle 410. After the lift cycle completes, the auxiliary component 408 may be deactivated until the next load event is predicted.

Turning now to FIG. 5, a method 500 for initiating an auxiliary component and/or secondary power source is shown. The method 500 may be one embodiment of the methods described in FIGS. 1-4, and can be executed by one or more processors (referred to herein as a processor) of a vehicle. In particularity, the method 500 illustrates a system in which a single threshold (e.g., a primary threshold, such as the presence of a cart) must be satisfied to initiate operation of auxiliary an component and/or secondary power source. This method may be implemented, for example, in systems where prediction of a load increase is based solely on object recognition data obtained from a perception system, without evaluating environmental or navigational interlock parameters.

At step 502, a primary dataset is received by the processor from a sensor. The primary dataset may include perception data from the sensor, such as images, radar data, sonar data, LiDAR data, thermal imaging data. The processors process the primary dataset to extract one or more primary attributes from the primary dataset, such as a type of object being perceived by the sensor, a distance to the object, an orientation of the object, text on the object, etc. Upon extracting the primary attributes, the processors then determine whether a specific object (e.g., a cart) is present within a predefined area in relation to the vehicle and if the present cart is to be loaded (e.g., if its color matches a colored cart associated with the vehicle or if known text characterizing it as associated with a pickup route of the vehicle is present). Various text or visual indicators (e.g., a QR code or other distinguishable visual element) may be used detected for use in determining the presence of the object.

In some embodiments, this primary dataset is associated with a parameter, such as a confidence score, and this parameter is compared to a primary threshold. When the parameter satisfies the primary threshold, the system determines that the object is suitable for collection. The predefined area may correspond to a bounding zone surrounding the perception area, such that detection within this region is sufficient to trigger operational planning of auxiliary systems.

If at step 502 the processor determines that there is no cart for collection present, the method 500 continues to step 504 in which the processors do not initiate operation of the auxiliary component and instead continues to search/detect a cart at step 502. This continuous monitoring loop may involve polling the sensor or re-processing new image frames to detect updated object attributes. The auxiliary system and secondary power source remain in a non-operational state to conserve energy and reduce system wear.

If at step 502 the processor determines that there is a cart for collection present, the method 500 continues to step 506. At step 506, the processor transmits control signals to the auxiliary component such as an E-PTO, or secondary power source, such as a hydrogen fuel cell, to initiate operation of the auxiliary component or secondary power source prior to arriving at the detected cart.

In some embodiments, the control signal includes activation instructions configured to energize a power source, begin hydraulic pressurization, or engage a drive motor coupled to a hydraulic pump. The auxiliary component may include a hydraulic system actuator, and the secondary power source may be any electrically or chemically powered generator configured to supply energy to that actuator.

Upon completion of the loading event, the processor may send a subsequent control signal to end operation of the auxiliary component and/or secondary power source until a cart is recognized again. In some embodiments, the instructions are sent in order to initiate operation early enough to result in appropriate hydraulic pressure is present prior to arriving at the cart for collection.

In these embodiments, a predictive delay model may be used based on current vehicle velocity, time to target, and hydraulic system ramp-up time. Such a delay model may be derived from a pre-calibrated lookup table or computed dynamically from telemetry.

A current speed of the vehicle may be used in calculating the timing of when to initiate operation/transmit instructions. This speed may be one of the parameters associated with the prediction and control system, and may further be compared to a velocity threshold to prevent premature initiation if the vehicle is moving too quickly to safely complete the auxiliary function cycle. In this way, the method accounts for both object presence and vehicle motion characteristics to ensure synchronized and efficient actuation.

In an exemplary embodiment, the method 500 is implemented in a vehicle equipped with camera mounted thereto, configured as a sensor that transmits visual data to a processor (e.g., one or more processors). As the vehicle proceeds along a residential collection route, the camera captures a sequence of images within the vehicle's perception area. These images form a primary dataset received at step 502.

The processor executes image recognition software to extract a set of primary attributes from the dataset, including shape, size, orientation, and presence of a label affixed to a container located along the curb. The extracted attributes include a confidence parameter indicating the likelihood that the detected object is a refuse cart. Based on the object's rectangular shape, vertical orientation, and the presence of known service route text (City Waste Services ”) on the container, the processor determines that the object satisfies a primary threshold-indicating a cart for collection is present within a predefined range from the vehicle.

At step 506, a control signal is transmitted to an auxiliary component in the form of an electric motor that drives a hydraulic pump. The motor receives power from a secondary power source, such as a hydrogen fuel cell mounted onboard. The control signal causes the motor to initiate operation approximately 1.5 seconds before the vehicle reaches the cart, based on the vehicle's speed of 8 miles per hour and a calculated time-to-target derived from real-time positioning data. Alternatively or additionally, the control signal is transmitted to a disconnect/the secondary power source to initiate the secondary power source (e.g., initiate a generator) in preparation for use of the auxiliary component.

As a result, hydraulic pressure is preemptively increased in the system prior to the lift assembly reaching the cart. When the cart is within reach, the lift assembly actuates smoothly without delay. Upon completion of the lift cycle and retraction of the lift assembly, the processor transmits a subsequent control signal to the motor and secondary power source, terminating operation of the auxiliary component to conserve energy. The system then resumes monitoring for the next primary dataset indicating a subsequent cart.

Turning now to FIG. 6, a method 600 for initiating an auxiliary component and/or secondary power source is shown. The method 600 may be one embodiment of the methods described in FIGS. 1-4, and can be executed by one or more processors (referred to herein as a processor) of a vehicle. In particularity, the method 600 illustrates a system in which two thresholds (e.g., a primary threshold, such as the presence of a cart, and a secondary threshold, such as being located in a geofenced position) must be satisfied to initiate operation of an auxiliary component.

Such a multi-threshold system provides enhanced reliability in predicting a load increase and reduces false positives by confirming both object-based and location-based parameters prior to initiating auxiliary functions.

At step 602, a primary dataset is received by the processor from a sensor. The primary dataset may include perception data from the sensor, such as images, radar data, sonar data, LiDAR data, thermal imaging data. The processors process the primary dataset to extract one or more primary attributes from the primary dataset, such as a type of object being perceived by the sensor, a distance to the object, an orientation of the object, text on the object, etc. Upon extracting the primary attributes, the processors then determine whether a specific object (e.g., a cart) is present within a predefined area in relation to the vehicle and if the present cart is to be loaded (e.g., if its color matches a colored cart associated with the vehicle or if known text characterizing it as associated with a pickup route of the vehicle is present). The extracted primary attributes may also include a detection confidence score, object classification label, and spatial coordinates, each of which may serve as parameters used to evaluate satisfaction of the primary threshold.

If at step 602 the processor determines that there is no cart for loading present, the method 600 continues to step 604 in which the processors do not initiate operation of the auxiliary component and/or secondary power source and instead continue to search/detect a cart at step 602. During this loop, sensor data may be buffered in real-time, with rolling updates evaluated to confirm the absence of valid cart-related features in the perception area.

If at step 602 the processor determines that there is a cart for loading present, the method 600 continues to step 606. At step 606, the processor determines if a secondary threshold (e.g., an interlock condition) is satisfied. The processor receives a secondary dataset from a second sensor. The secondary dataset may include environmental data, navigation data, and/or vehicle data. Within the received data is included environmental attributes of an environment surrounding the vehicle, navigational attributes of a navigation upon which the vehicle is traveling, and/or vehicle attributes of various operating parameters of the vehicle. This dataset is processed to extract the various secondary attributes stored within the secondary dataset. A secondary attribute is compared against a known secondary threshold to determine if the threshold is met, and thereby the secondary condition is met. Example secondary attributes may include a GPS location parameter, current vehicle speed, direction of travel, or a timestamp. The processor may compare a current geographic coordinate value to a known geofenced region, or compare the current heading to a desired trajectory, thereby satisfying the secondary condition only when contextual navigation or system readiness criteria are met.

If at step 606 the processor determines that the secondary condition is not met because the secondary threshold is not satisfied, the method 600 continues to step 604 at which the processor does not initiate operation of an auxiliary component and instead continues to receive secondary data and determine if the secondary threshold is met (e.g., returns to step 606). In some embodiments, this allows the perception system to remain armed and ready, while the interlock system waits for route alignment, speed stabilization, or operator confirmation.

If at step 606 the processor determines that the secondary condition is met because the secondary threshold is satisfied, the method 600 continues to step 608. At step 608, the processor transmits control signals to the auxiliary component such as an E-PTO, or secondary power source, such as a hydrogen fuel cell, to initiate operation of the auxiliary component and/or secondary power source prior to arriving at the detected cart. Upon completion of the loading event, the processor may send a subsequent control signal to end operation of the auxiliary component and/or secondary power source until a cart is recognized again. The transmitted control signal may contain a command to begin pressurizing a hydraulic system, energize a drive motor, or start a chemical reaction in a fuel cell stack. The system may also incorporate an activation delay parameter derived from vehicle speed to ensure that sufficient hydraulic pressure is available precisely when needed. Post-operation, shutdown instructions may include ramp-down or cooldown sequences to extend system lifespan.

In an exemplary embodiment, a refuse vehicle is driving through a residential neighborhood. At step 602, the front-mounted vision system detects a cart positioned near the curb and classifies it as a valid collection target based on size, shape, and a visible service route identifier. The primary attribute—object type with associated confidence level—satisfies the primary threshold.

At step 606, the vehicle's GPS module provides a current location dataset, which is processed to extract a secondary attribute corresponding to the vehicle's geographic position. This position is compared to a geofenced polygon stored in memory. The result indicates that the vehicle is within the designated service zone, satisfying the secondary threshold.

At step 608, the processor transmits a control signal to initiate operation of the auxiliary component—an electric motor powering a hydraulic pump. The motor draws power from a secondary power source, such as a hydrogen fuel cell, which may alternatively or additionally be initiated in response to the satisfaction of the interlocks. The hydraulic system is thus primed before the vehicle reaches the cart. Once the lift sequence is complete, the processor transmits another control signal to deactivate the motor and/or secondary power source, returning the system to a standby state while scanning for the next primary dataset.

While the methods 500-600 are shown as progressing in series, with each condition being checked prior to the subsequent condition being checked, it should be understood that one or more of the condition-checking steps may also be continuously checked in parallel and move to the final initiation step upon all necessary conditions being met. For example, in some embodiments, the primary threshold and secondary threshold may be independently evaluated in real time, and upon both being satisfied, a control signal may be immediately transmitted to initiate operation of the auxiliary component and/or secondary power source. In other embodiments, the system may prioritize one threshold (e.g., cart detection) as a gating condition, with the second condition (e.g., geographic location or vehicle speed) being evaluated only upon detection of the gating event.

Moreover, while the above methods are described with reference to discrete steps such as receiving datasets, extracting attributes, and comparing to thresholds, it should be appreciated that these steps may be implemented using streaming data, asynchronous sensor polling, or event-driven logic architectures. For example, a controller may be continuously executing machine vision algorithms on incoming camera feeds while concurrently evaluating GPS position and vehicle telemetry against interlock conditions. The determination to initiate the auxiliary component may therefore result from a set of concurrently satisfied parameter evaluations, rather than from a strictly ordered execution of steps.

Additionally, while the embodiments above describe two or more thresholds (e.g., primary and secondary) as being required prior to transmitting control signals, alternative embodiments may include hierarchical or weighted threshold systems, confidence scoring models, or user-configurable rules that dynamically determine whether a condition is met. For instance, a combined evaluation may rely on a weighted scoring system in which high confidence in cart detection may reduce the strictness of geofence or speed constraints, or vice versa.

The methods described with respect to FIGS. 5 and 6 are not limited to refuse collection vehicles, but may be applied more broadly to any autonomous or semi-autonomous system where conditional logic governs activation of a secondary system or power source in response to sensor-derived parameters. The initiation logic may apply to other load events, mechanical actuation events, or energy allocation routines in vehicles, industrial equipment, or robotics platforms. Thus, the examples and use cases provided herein are illustrative rather than limiting.

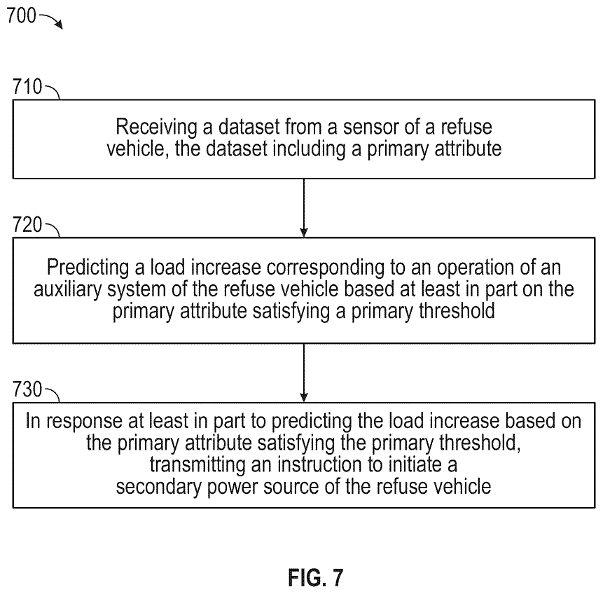

Turning now to FIG. 7, a computer-implemented method 700 is shown for predicting a load increase and initiating a secondary power source in a refuse vehicle. The computer- implemented method 700 may be performed by one or more processors disposed onboard the refuse vehicle, with instructions stored in a computer-readable, non-transitory storage medium. The computer-implemented method 700 may be used to enhance efficiency and responsiveness in powering an auxiliary system of the vehicle by anticipating upcoming operational demands based on sensor data.

At step 710, the method includes receiving a dataset from a sensor of the refuse vehicle. The dataset may be received by one or more processors configured to execute instructions stored on a computer-readable, non-transitory storage medium. The dataset includes perception data representative of an environment proximate to the vehicle and is used to extract one or more parameters—such as an object classification, position, orientation, or identification marker—associated with external objects or environmental features.

The sensor may be a vision-based sensor (e.g., camera), a time-of-flight sensor (e.g., LiDAR), a proximity sensor (e.g., ultrasonic transducer), or a fusion sensor module comprising multiple input modalities. The dataset received from the sensor may be formatted as an image array, point cloud, depth map, or temporal waveform and may include metadata such as timestamp, GPS coordinate, and vehicle heading. The dataset is stored temporarily or persistently in a memory associated with the vehicle controller or offloaded to a parallel computing resource.

In some embodiments, the sensor dataset is preprocessed to normalize values or apply filtering, and one or more attributes are extracted from the dataset by executing feature extraction code modules residing on the computer-readable, non-transitory storage medium. These extracted attributes are then made available for evaluation against one or more thresholds, as further described in step 720. Parameters extracted from the dataset may include object bounding boxes, pixel intensity histograms, classification confidence scores, text detected on an object, or Cartesian coordinates of a point cluster representing a detected object.

The dataset may also be associated with a perception area—defined as a region in the forward, lateral, or rearward direction of the vehicle—in which the sensor is configured to detect objects. The processor may determine whether an object is located within this perception area and assign context to the dataset accordingly (e.g., identifying the object as a “target for interaction” or “external obstruction”).

In an illustrative embodiment, a forward-facing RGB camera mounted on the cab of a refuse vehicle captures a frame of visual data approximately every 250 milliseconds. A captured frame is transmitted to an onboard processor, which stores it in volatile memory and applies a convolutional neural network (CNN) trained to identify refuse carts. In this frame, the network identifies a rectangular object situated near the right-hand curb and assigns it a classification of “cart” with 92% confidence. The extracted attributes include: object label=“cart,” bounding box=(x₁, y₁, x₂, y₂), and confidence score=0.92. This information forms a primary dataset that is structured and indexed for threshold evaluation in subsequent processing stages.

By receiving and extracting these attributes from a sensor dataset, the processor generates structured data that can be compared against predefined thresholds to determine whether a condition indicative of a load event is present. This step enables object-based situational awareness and supports downstream control logic responsible for predicting a load increase and managing auxiliary power systems accordingly.

At step 720, the method includes predicting a load increase corresponding to an operation of an auxiliary system of the refuse vehicle based at least in part on the primary attribute satisfying a primary threshold. The primary attribute may be one or more parameters extracted from the dataset received at step 710, the dataset having been captured by a sensor (e.g., camera, LiDAR, radar, or ultrasonic module) and processed by a processor executing instructions stored on a computer-readable, non-transitory storage medium.

The prediction is made using one or more of the extracted parameters—such as an object classification label, spatial position relative to the vehicle, bounding box dimensions, orientation angle, or a text indicator extracted from the object—each of which may be individually or collectively evaluated against a corresponding threshold. The processor determines whether one or more of these parameters indicate that a load event is likely to occur, such as a cart lifting or dumping operation that would engage an auxiliary system (e.g., a hydraulic lift, compactor, or ejector). The prediction may occur in real time as new datasets are received or may be updated periodically using rolling evaluations of prior image frames or sensor data buffers.

In some embodiments, the primary threshold may correspond to a confidence level threshold for object detection, a minimum bounding box size, a maximum lateral offset, or a predefined geospatial relationship to the vehicle's operating path. If the extracted parameter satisfies the applicable threshold, the processor identifies the object as actionable and predicts that a corresponding auxiliary system will be required shortly. This prediction constitutes an anticipatory action to initiate power delivery, pressure buildup, or actuator priming within the auxiliary system.

Continuing the example from step 710, the processor receives a primary dataset comprising an image frame captured by the forward-facing RGB camera. This dataset includes pixel values, positional metadata, and timestamp information. The dataset is processed by an onboard object detection module—executing on a computer-readable, non-transitory storage medium—which identifies a rectangular object situated along the vehicle's right-hand perception boundary. The object is classified as a “refuse cart” with a confidence score of 92%, and its position is localized 2.4 meters ahead and 1.0 meter to the right of the vehicle's reference frame.

The processor extracts this classification label, bounding box, positional coordinates, and confidence score as parameters from the dataset. These parameters are then evaluated against stored primary thresholds. Specifically, the classification label is required to match “cart,” the confidence score must exceed 90%, and the object must lie within a forward detection distance of less than 3.0 meters and within 1.5 meters laterally from the vehicle's centerline.

Each of these parameters satisfies its corresponding primary threshold, and therefore the processor determines that the object qualifies as a valid refuse cart within the effective range of the vehicle's lift system. Based on this determination, the processor predicts a load increase associated with the upcoming engagement of the auxiliary system (e.g., a hydraulic lift assembly). This prediction is made using logic stored in a cart-handling module within the system memory, and it may include an estimated time-to-engagement calculated from the vehicle's current speed and the distance to the cart.

In response to the predicted load increase, the processor initiates downstream actions, such as transmitting control signals to begin priming an auxiliary hydraulic circuit or activating a secondary power source such as a hydrogen fuel cell. The system may further schedule the activation to ensure that sufficient hydraulic pressure is available at the exact time the lift assembly reaches the cart, thereby avoiding delays and ensuring efficient energy use. The entire prediction and response process is executed using instructions stored on a computer-readable, non-transitory storage medium.

In an additional or alternative embodiment, the processor receives, in parallel with or serial to the primary dataset, a secondary dataset from an onboard inertial measurement unit (IMU) and wheel speed sensor. This secondary dataset includes kinematic parameters of the vehicle, such as longitudinal velocity, acceleration, and brake status. The processor extracts a vehicle deceleration parameter from the dataset, which is defined as a rate of change in forward speed over time. In some embodiments, the data from secondary dataset may be alternatively included in the primary dataset.

The extracted deceleration parameter is then compared to a stored secondary threshold, which requires that the vehicle be actively decelerating toward the identified object at a rate greater than a predefined minimum (e.g., −0.5 m/s²). This ensures that the vehicle is not merely passing a cart at speed, but is in fact intending to stop or slow for engagement with the auxiliary system. This threshold acts as an interlocking condition that supplements the primary cart detection.

If the deceleration parameter satisfies the secondary threshold, and the previously evaluated primary attributes confirm the presence and position of a cart within the target envelope, the processor concludes that both conditions are satisfied. As a result, the system transitions from a monitoring state to an activation state, wherein a control signal is transmitted to initiate the auxiliary component (e.g., spinning up the electric motor that drives the hydraulic lift system).

In some embodiments, this dual-threshold structure ensures that energy is only expended to activate the auxiliary system when the vehicle is physically preparing to engage a cart—thereby reducing false activations when passing stationary objects or traveling at full speed.

At step 730, the method includes, in response at least in part to predicting the load increase, transmitting an instruction to initiate a secondary power source of the refuse vehicle. This instruction may take the form of a control signal generated by a processor and routed through a control system to initiate operation of a power management subsystem. The secondary power source may be, for example, a hydrogen fuel cell, onboard generator, high-capacity battery pack, ultracapacitor, or hybrid subsystem configured to supplement or drive high-load vehicle operations.

The control signal may include activation parameters such as an electrical enable command, a voltage setpoint, a fuel cell startup sequence, or a torque demand curve. These signals may be generated based on a set of real-time inputs stored in system memory or computed dynamically. The transmission of the instruction is executed by the processor operating under instructions retrieved from a computer-readable, non-transitory storage medium that defines conditional logic for activation of the secondary power source upon satisfaction of load prediction criteria.

The secondary power source is coupled to an auxiliary system of the vehicle, such as an electric motor driving a hydraulic pump, which in turn supplies pressurized hydraulic fluid to actuators involved in lifting, compacting, or ejecting refuse. The goal of the early activation is to ensure the auxiliary system reaches a ready state (e.g., stable pressure or voltage) prior to physical engagement with the detected cart.

Continuing the example from step 720, upon confirming the presence of a refuse cart using the primary dataset, and verifying vehicle deceleration from the IMU-derived secondary dataset, the processor determines that both thresholds are satisfied. The vehicle is slowing at −0.7 m/s², exceeding the minimum deceleration threshold. The cart is located 2.4 meters ahead, within the lateral and longitudinal bounds defined in the primary threshold parameters, and the classification confidence is above 90%.

In response, the processor transmits a control signal to initiate a hydrogen fuel cell onboard the vehicle. This signal includes a startup command issued to a power electronics controller responsible for regulating current flow to the electric motor. The electric motor, once energized, begins spinning a hydraulic pump that increases fluid pressure within the lift assembly circuit.

By the time the vehicle reaches the detected cart (predicted to occur within 1.8 seconds based on speed and distance), the hydraulic system is fully primed. The lift operation is performed immediately without delay, powered by energy supplied by the now-active secondary power source. After the lift and dump sequence completes, the processor may transmit a second control signal to shut down the fuel cell or return it to standby, thereby conserving fuel and thermal cycles.

This entire sequence—starting from object detection, through deceleration monitoring, to power system engagement—is executed autonomously or semi-autonomously by one or more processors using instructions stored on a computer-readable, non-transitory storage medium and allows the refuse vehicle to operate responsively, efficiently, and intelligently across variable real-world conditions.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general-purpose single-or multi-chip processor, a digital signal processor (DSP), an application-specific integrated circuit (ASIC), a field programmable gate array (FPGA), or other programmable logic device, discrete gate or transistor logic, discrete hardware components, or any combination thereof designed to perform the functions described herein. In some embodiments, one or more processes or modules may be stored as instructions on a computer-readable, non-transitory storage medium. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration.

In various embodiments, particular processes and methods may be performed by circuitry or processing logic that is configured to execute instructions stored on a computer-readable, non-transitory storage medium. The memory (e.g., memory, memory unit, storage device) may include one or more devices (e.g., RAM, ROM, flash memory, hard disk storage) for storing data and/or computer code for completing or facilitating the various processes, layers, and modules described in the present disclosure. The memory may be or include volatile memory or non-volatile memory and may include database components, object code components, script components, or any other type of information structure for supporting the various activities and structures described herein. According to an exemplary embodiment, the memory is communicably connected to the processor via a processing circuit and includes computer code for executing (e.g., by the processing circuit or processor) the one or more processes described herein using instructions stored on a computer-readable, non-transitory storage medium.

The present disclosure contemplates methods, systems, and program products on any computer-readable, non-transitory storage medium for accomplishing various operations. The embodiments of the present disclosure may be implemented using existing computer processors, or by a special-purpose processor for an appropriate system, incorporated for this or another purpose, or by a hardwired system. Embodiments within the scope of the present disclosure include program products comprising a computer-readable, non-transitory storage medium for carrying or having machine-executable instructions or data structures stored thereon. Such media can include any medium that can be accessed by a general-purpose or special-purpose computer or other machine with a processor. By way of example, such media may include RAM, ROM, EPROM, EEPROM, optical disk storage, magnetic disk storage, or other magnetic or optical storage devices, so long as they are computer-readable and non-transitory. Machine-executable instructions include, for example, instructions and data that cause a processor or computing device to perform one or more specified functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from the scope of the present disclosure or from the spirit of the appended claims.

What is claimed is:

1. A refuse vehicle comprising:
a primary power source;
a secondary power source;
an auxiliary system electrically coupled to the secondary power source;
a sensor;
one or more processors; and
a computer-readable, non-transitory storage medium comprising instructions that, when executed by the one or more processors, cause the one or more processors to execute a method comprising:
receiving a dataset from the sensor, the dataset including a primary attribute;
predicting a load increase corresponding to an operation of the auxiliary system based at least in part on the primary attribute satisfying a primary threshold; and
in response at least in part to predicting the load increase based on the primary attribute satisfying the primary threshold, transmitting an instruction to initiate the secondary power source.

2. The refuse vehicle of claim 1, wherein the method further comprises:
receiving an indication of a completion of the operation of the auxiliary system; and
in response at least in part to receiving the indication of the completion of the operation of the auxiliary system, transmitting a second instruction to terminate the secondary power source.

3. The refuse vehicle of claim 1, wherein the primary power source is electrically coupled to a drivetrain of the refuse vehicle.

4. The refuse vehicle of claim 1, wherein the auxiliary system comprises:
an auxiliary component electrically coupled to the secondary power source; and
a device cooperatively coupled to the auxiliary component.

5. The refuse vehicle of claim 4, wherein the auxiliary component is one of an electric power take-off, an electric motor, and a hydraulic pump.

6. The refuse vehicle of claim 4, wherein the device is one of a lift assembly, an ejector, a compactor, and a vehicle access.

7. The refuse vehicle of claim 1, wherein the secondary power source is an electric generator onboard the refuse vehicle.

8. The refuse vehicle of claim 1, wherein the secondary power source is a hydrogen fuel cell.

9. The refuse vehicle of claim 7, wherein the electric generator is powered by internal combustion of one of hydrogen, renewable natural gas, compressed natural gas, gasoline, and e-fuel.

10. A computer-readable, non-transitory storage medium comprising instructions that, when executed by one or more processors, cause the one or more processors to execute a method comprising:
receiving a dataset from a sensor of a refuse vehicle, the dataset including a primary attribute;
predicting a load increase corresponding to an operation of an auxiliary system of the refuse vehicle based at least in part on the primary attribute satisfying a primary threshold; and
in response at least in part to predicting the load increase based on the primary attribute satisfying the primary threshold, transmitting an instruction to initiate a secondary power source of the refuse vehicle.

11. The computer-readable, non-transitory storage medium of claim 10, wherein the method further comprises:
receiving an indication of a completion of the operation of the auxiliary system; and
in response at least in part to receiving the indication of the completion of the operation of the auxiliary system, transmitting a second instruction to terminate the secondary power source.

12. The computer-readable, non-transitory storage medium of claim 10, wherein a primary power source is electrically coupled to a drivetrain of the refuse vehicle.

13. The computer-readable, non-transitory storage medium of claim 10, wherein the auxiliary system comprises:
an auxiliary component electrically coupled to the secondary power source; and
a device cooperatively coupled to the auxiliary component.

14. The computer-readable, non-transitory storage medium of claim 13, wherein the auxiliary component is one of an electric power take-off, an electric motor, and a hydraulic pump.

15. The computer-readable, non-transitory storage medium of claim 13, wherein the device is one of a lift assembly, an ejector, a compactor, and a vehicle access.

16. The computer-readable, non-transitory storage medium of claim 10, wherein the secondary power source is an electric generator onboard the refuse vehicle.

17. The computer-readable, non-transitory storage medium of claim 10, wherein the secondary power source is a hydrogen fuel cell.

18. The computer-readable, non-transitory storage medium of claim 16, wherein the electric generator is powered by internal combustion of one of hydrogen, renewable natural gas, compressed natural gas, gasoline, and e-fuel.

19. A method comprising:
receiving a dataset from a sensor of a refuse vehicle, the dataset including a primary attribute;
predicting a load increase corresponding to an operation of an auxiliary system of the refuse vehicle based at least in part on the primary attribute satisfying a primary threshold; and
in response at least in part to predicting the load increase based on the primary attribute satisfying the primary threshold, transmitting an instruction to initiate a secondary power source of the refuse vehicle.

20. The method of claim 19, further comprising:
receiving an indication of a completion of the operation of the auxiliary system; and
in response at least in part to receiving the indication of the completion of the operation of the auxiliary system, transmitting a second instruction to terminate the secondary power source.
